(19) United States
(12) Patent Application Publication
(10) Pub. No.: US 2018/0329431 A1
(43) Pub. Date: Nov. 15, 2018

(54) THERMAL IMAGE POSITIONING SYSTEM AND POSITIONING METHOD THEREOF

(71) Applicant: Chunghwa Picture Tubes, LTD., Taoyuan City (TW)

(72) Inventors: Min-Chung Cheng, New Taipei City (TW); Chun-Wei Wang, Taipei City (TW); Ru-Yi Hsieh, Taoyuan City (TW)

(73) Assignee: Chunghwa Picture Tubes, LTD., Taoyuan City (TW)

(21) Appl. No.: 15/652,269

(22) Filed: Jul. 18, 2017

(30) Foreign Application Priority Data
May 12, 2017 (CN) 201710332841.6

(51) Int. Cl. G05D 1/10; G01S 19/42; G01S 5/16; B64C 39/02; H04N 5/33; H04N 7/18; H04N 9/09

(52) U.S. Cl. CPC G05D 1/101; G01S 19/42; G01S 5/16; B60L 11/182; H04N 5/33; H04N 7/181; H04N 9/09; B64C 39/024

(57) ABSTRACT

A thermal image positioning system and a positioning method thereof are provided. The thermal image positioning method includes: configuring a plurality of thermal image generators in a space, where the thermal image generators respectively generate a plurality of thermal images; making a carrier to move according to the thermal images, providing a thermal image receiver to respectively receive the thermal images, and respectively generating a plurality of distance information according to the thermal images; and generating coordinate information of the space according to the distance information.

### CROSS-REFERENCE TO RELATED APPLICATION

This application claims the priority benefit of China application serial no. 201710332841.6, filed on May 12, 2017. The entirety of the above-mentioned patent application is hereby incorporated by reference herein and made a part of this specification.

### BACKGROUND OF THE INVENTION

### Field of the Invention

The invention relates to a positioning system and a positioning method, and particularly relates to a thermal image positioning system and a positioning method thereof.

### Description of Related Art

In today's society, unmanned vehicles are widely used, and become important tools in daily life.

In existing techniques, the unmanned vehicle is generally controlled and communicated through a communication medium, so as to execute various functions. However, in an environment that signals of the communication medium cannot be transmitted, or during a period that a network service is interrupted, the unmanned vehicle cannot be controlled to carry on required tasks, which causes usage inconvenience.

### SUMMARY OF THE INVENTION

The invention is directed to a thermal image positioning method and a positioning system, and through recognition of a thermal image, positioning is implemented under an environment of none communication medium.

The invention provides a thermal image positioning method including: disposing a plurality of thermal image generators in a space, where the thermal image generators respectively generate a plurality of thermal images; making a carrier to move according to the thermal images, providing a thermal image receiver to respectively receive the thermal images, and respectively generating a plurality of distance information according to the thermal images; and generating coordinate information of the space according to the distance information.

In an embodiment of the invention, the thermal image positioning method further includes: configuring the thermal image receiver on the carrier.

In an embodiment of the invention, the step of respectively generating the plurality of the distance information according to the thermal images includes generating each distance information corresponding to each of the thermal image generators according to a color variation of each of the thermal images.

In an embodiment of the invention, the thermal image positioning method further includes: recognizing a display pattern of each of the thermal images, such that the carrier executes an operation instruction according to the display pattern.

In an embodiment of the invention, the thermal image positioning method further includes: configuring at least one magnetic signal generator, where the magnetic signal generator is located adjacent to at least one of the thermal image generators; and making the carrier to receive a magnetic signal sent by the magnetic signal generator, and charging the carrier according to the magnetic signal.

In an embodiment of the invention, the magnetic signal is at least one of a magnetic resonance signal and a magnetic induction signal.

In an embodiment of the invention, after the step of configuring a plurality of the thermal image generators in the space, the method further includes: obtaining position information of the thermal image generators in the space through a global positioning system; and making the carrier to move to one of the thermal image generators according to the position information.

In an embodiment of the invention, after the step of making the carrier to move to a selected thermal image generator of the thermal image generators according to the position information, the method further includes: making the thermal image receiver to receive a selected thermal image generated by the selected thermal image generator, and moving the carrier to another one of the thermal image generators according to the selected thermal image.

The invention provides a thermal image positioning system including a plurality of thermal image generators, a carrier, a controller and a thermal image receiver. The thermal image generators are disposed in a space to respectively generate a plurality of thermal images. The controller is disposed on the carrier. The thermal image receiver is disposed on the carrier and is coupled to the controller. The thermal image receiver receives the thermal images. The controller respectively generates a plurality of distance information according to the thermal images, and generates coordinate information of the space according to the distance information.

According to the above description, positioning and moving of the carrier are implemented through the thermal images provided by the thermal image generators. In this way, under a condition of none communication medium, the carrier may move in a region, and may provide related services such as cargo loading, operation, unloading, or image capturing, etc., without being interfered by obstacles.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a thermal image positioning method according to an embodiment of the invention.

FIG. 2 is a schematic diagram of a thermal image positioning device and operations thereof according to an embodiment of the invention.

FIG. 3 is a flowchart illustrating a thermal image positioning method according to another embodiment of the invention.

FIG. 4 is a schematic diagram of an implementation of a carrier according to an embodiment of the invention.

FIG. 5 is a schematic of an implantation of a thermal image tag device according to an embodiment of the invention.

### DESCRIPTION OF EMBODIMENTS

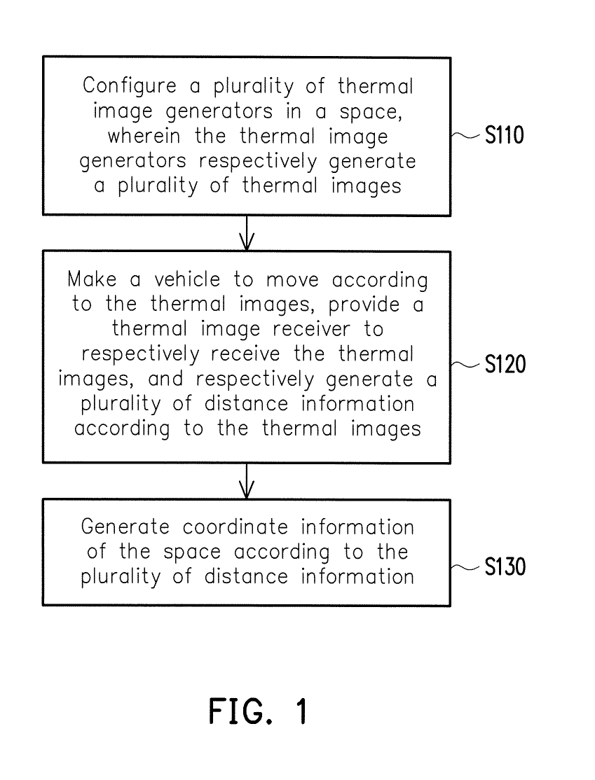

Referring to FIG. 1, FIG. 1 is a flowchart illustrating a thermal image positioning method according to an embodiment of the invention. In step S110, a plurality of thermal image generators is disposed in a space, where the thermal image generators respectively generate a plurality of thermal images. It should be noted that the thermal image generators may be disposed at different positions in the space. In an embodiment of the invention, the thermal image generators may be disposed at different corners of the space, and when a carrier moves according to the thermal images, the carrier may pass by each region in the space.

Then, in step S120, the carrier is made to move according to positions where the thermal images are generated, and a thermal image receiver is provided to receive the thermal images, and a plurality of distance information is respectively generated according to the thermal images. In detail, the thermal image receiver can be disposed on the carrier, and when the carrier moves according to each of the thermal images, the thermal image receiver may scan the thermal images on a moving path. When the thermal image receiver receives the thermal image, the carrier may determine the distance information between the carrier and the thermal image generator corresponding to the thermal image according to the thermal image received by the thermal image receiver. Further, along with movement of the carrier, a distance between the carrier and the thermal image is changed, and a color of the thermal image sensed by the thermal image receiver is accordingly changed. Therefore, the carrier may calculate the distance information between the carrier and the thermal image generator based on a color variation of the thermal image.

In the present embodiment, the carrier can be sequentially moved to each of the thermal image generators, and may generate the corresponding distance information according to a color variation of each of the thermal images generated by each of the thermal image generators. In this way, after the carrier collects enough distance information according to the plurality of thermal images, the carrier may construct coordinate information of the space according to the distance information (step S130).

The carrier may calculate the coordinate information of the space according to a moving speed of the carrier. In an embodiment of the invention, the carrier can be an unmanned aerial vehicle (UAV), unmanned vehicle, or unmanned carriers well known by those skilled in the art.

It should be noted that in the present embodiment, when configuration of the thermal image generators is completed, position information of the thermal image generators in the space can be input to the carrier in advance. In this way, the carrier may move according to the above position information and search the thermal images generated by the thermal image generators. The position information of the thermal image generators in the space can be obtained through, for example, a global positioning system (GPS).

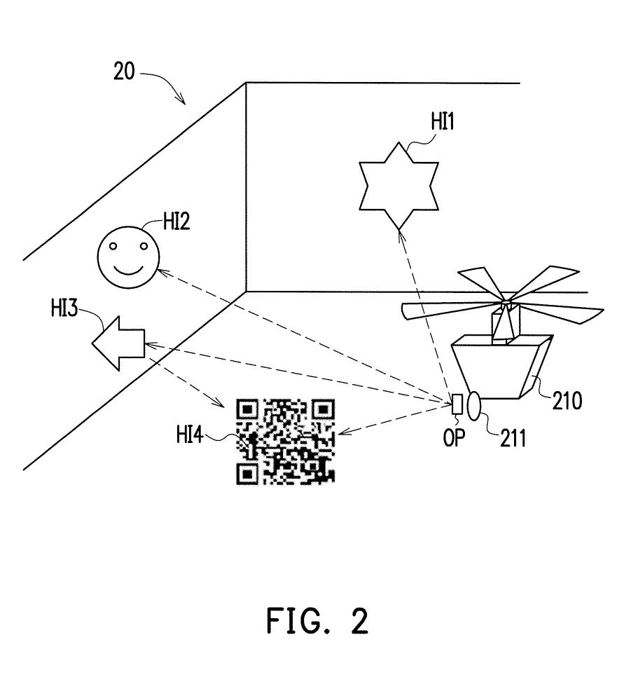

It should be noted that the thermal image generated by the thermal image generator may include at least one of a general image, a text and a code that records information, for example, a bar code, a two-dimensional bar code, or a quick response code (QR code). Namely, besides that the carrier may obtain the distance information according to a color variation of the thermal image, but may also receive an operation instruction by analyzing the information recorded in the thermal image, and execute the received operation instruction. Referring to FIG. 2, FIG. 2 is a schematic diagram of a thermal image positioning device and operations thereof according to an embodiment of the invention. A carrier 210 is a UAV, and is disposed to move in a space 20. A plurality of thermal image generators is disposed in the space 20, and respectively generates a plurality of thermal images HI1-HI4. The thermal images HI1-HI2 are general images, the thermal image HI3 is an indication image, and the thermal image HI4 is a QR code. A thermal image receiver 211 is disposed on the carrier 210 for sensing the thermal images HI1-HI4.

During a process of executing a positioning operation, the carrier 210 may set off from an origin point (a safety point) OP, and moves toward a position where the thermal image HI1 is produced, and when the thermal image receiver 211 receives the thermal image HI1, the carrier 210 may generate distance information according to a color variation of the received thermal image HI1. When a distance between the carrier 210 and the thermal image HI1 is smaller than a threshold, the carrier 210 may return back to the origin point OP.

Then, the carrier 210 may again set off from the origin point OP, and moves toward the thermal image HI2, and generates another set of distance information according to a color variation of the thermal image HI2.

In this way, the carrier 210 may produce a plurality sets of distance information according to the color variations of the thermal images HI1-HI4 during the moving process, and may calculate coordinate information of the space 20 according to the plurality of distance information.

It should be noted that in the present embodiment, the thermal image HI3 can be an indication image. The carrier 210 may recognize the thermal image HI3, and execute an operation instruction according to information conveyed by the thermal image HI3. In FIG. 2, after the carrier 210 recognizes the indication image of the thermal image HI3, the carrier 210 may directly move to the position of the thermal image HI4 without returning back to the origin point OP.

Moreover, the thermal image HI4 can be a QR code, and when the carrier 210 recognizes the information of the QR code of the thermal image HI4, the carrier 210 may execute an operation instruction conveyed by the thermal image HI4, for example, perform a cargo loading or unloading operation according to the position where the thermal image HI4 is produced.

On the other hand, generation of the thermal images HI1-HI4 can be implemented through coils of electronic circuits, materials that can be electrically heated, or other manners well known by those skilled in the art, which is not limited by the invention. It should be noted that magnetic signal generators can be disposed in some thermal image generators used for generating the thermal images, where the magnetic signal generators, for example, include wireless charging coils for generating magnetic signals. The magnetic signals can be provided to the carrier 210 to wirelessly charge the carrier 210.

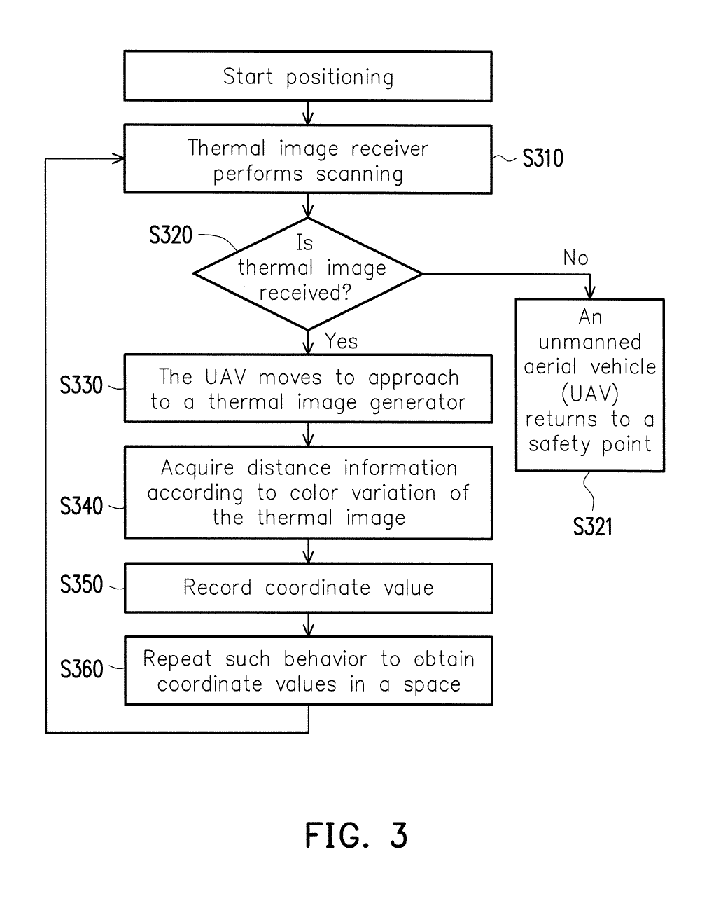

Referring to FIG. 3, FIG. 3 is a flowchart illustrating a thermal image positioning method according to another embodiment of the invention. In step S310, the thermal image receiver performs a scan operation, and during a moving process of the UAV (carrier), the thermal image receiver executes a step S320 to determine whether a thermal image is receiver. If the thermal image receiver keeps being unable to receive the thermal image, the UAV returns to the safety point (step S321). Comparatively, if the thermal image receiver successfully receives the thermal image, a step S330 is executed, by which the UAV gradually approaches to the thermal image generator generating the thermal image, and in step S340, distance information is obtained according to a color variation of the thermal image. In step S350, a coordinate value is calculated according to the distance information through an algorithm. In step S360, the coordinate values generated by executing the above steps repeatedly are integrated to construct integral coordinate information in the space.

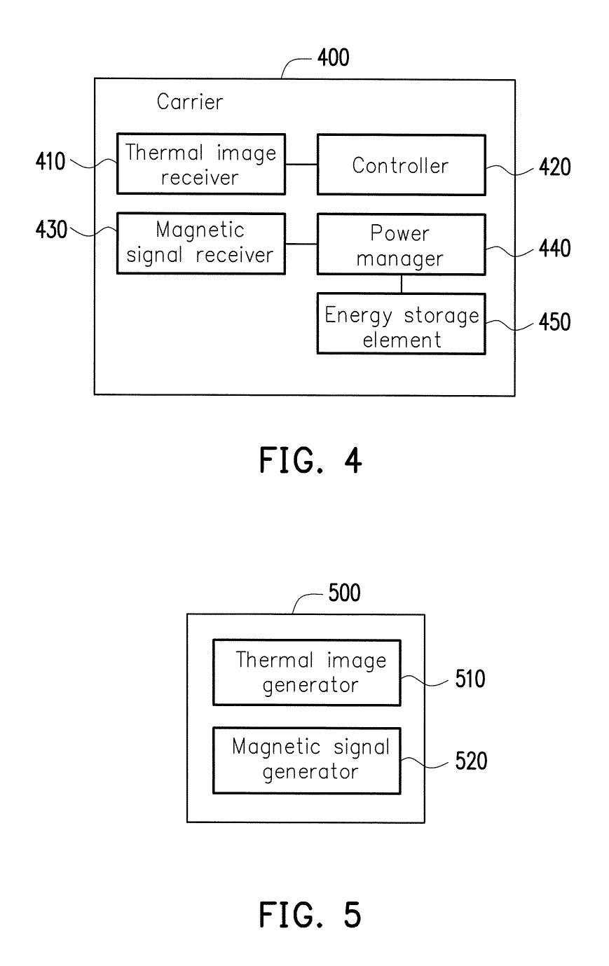

Referring to FIG. 4, FIG. 4 is a schematic diagram of an implementation of a carrier according to an embodiment of the invention. The carrier 400 includes a thermal image receiver 410, a controller 420, a magnetic signal receiver 430, a power manager 440 and an energy storage device 450. The thermal image receiver 410 is coupled to the controller 420, where the thermal image receiver 410 is disposed to receive thermal images, and the controller 420 may generate distance information by determining color variations of the thermal images. The controller 420 may analyze the thermal image received by the thermal image receiver 410, and when the thermal image records related information of an operation instruction, the controller 420 may analyze the operation instruction, and control the carrier 400 to operate according to the operation instruction.

The magnetic signal receiver 430 is disposed to receive a magnetic signal. When the magnetic signal receiver 430 receives the magnetic signal adapted to implement wireless charging, the magnetic signal receiver 430 may transmit the magnetic signal to the power manager 440. The power manager 440 may generate a charging voltage according to the magnetic signal, and charge the energy storage device 450 (for example, a battery) by using the charging voltage.

The magnetic signal can be at least one of a magnetic resonance signal and a magnetic induction signal. In this way, the carrier 400 may implement the wireless charging operation in a contact manner or non-contact manner.

It should be noted that the controller 420 and the power manager 440 can be coupled or integrated with each other to form a same processor, the embodiment of FIG. 4 is only an example, and is not used for limiting the scope of the invention.

Referring to FIG. 5, FIG. 5 is a schematic of an implantation of a thermal image tag device according to an embodiment of the invention. A thermal image generator 510 of the invention can be disposed in the space by configuring in the thermal image tag device 500. Moreover, the thermal image tag device 500 may include a magnetic signal generator 520. The thermal image tag device 500 having the magnetic signal generator 520 may serve as a charging station of the carrier. When the carrier approaches to the thermal image tag device 500, the carrier may learn that the thermal image tag device 500 is the charging station through the thermal image generated by the thermal image generator 510, in this case, when the carrier determines that an electric quantity of the energy storage device is lower than a predetermined value, the carrier may approach to or contact the magnetic signal generator 520 to implement power charging. In this way, the carrier is ensured to operate continuously.

Certainly, not all of the thermal image tag devices in the space are required to be disposed with the magnetic signal generator 520. A part of the thermal image tag devices only includes the thermal image generator 510, so as to decrease the system cost.

It should be noted that the quantity of the thermal image generators 510 required to be disposed in the space and configuration positions thereof can be dynamically adjusted during the positioning process. For example, when a moving trajectory of a part of the regions in the space is relatively complicated, more thermal image generators 510 can be disposed in these regions. Alternatively, after the positioning is completed, if the carrier is easy to collide with obstacles in some regions, the positions of the thermal image generators 510 in the regions can be adjusted, and positioning is re-performed, so as to acquire better coordinate information.

In summary, the invention provides a plurality of thermal image generators, and during a moving process of the carrier, the carrier acquires the distance information through color variation of the thermal images, and further construct coordinate information in the space according to the distance information. In this way, under a condition of none communication medium, the carrier may move in a region, and may provide related services such as cargo loading, operation, unloading, or image capturing, etc., without being interfered by obstacles.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A thermal image positioning method, comprising:
configuring a plurality of thermal image generators in a space, wherein the thermal image generators respectively generate a plurality of thermal images;
making a carrier to move according to the thermal images, providing a thermal image receiver to respectively receive the thermal images, and respectively generating a plurality of distance information according to the thermal images; and
generating coordinate information of the space according to the plurality of distance information.

2. The thermal image positioning method as claimed in claim 1, further comprising:
disposing the thermal image receiver on the carrier.

3. The thermal image positioning method as claimed in claim 1, wherein the step of respectively generating the plurality of distance information according to the thermal images comprising:
generating each distance information corresponding to each of the thermal image generators according to a color variation of each of the thermal images.

4. The thermal image positioning method as claimed in claim 1, further comprising:
recognizing a display pattern of each of the thermal images, such that the carrier executes an operation instruction according to the display pattern.

5. The thermal image positioning method as claimed in claim 1, further comprising:
configuring at least one magnetic signal generator, wherein the at least one magnetic signal generator is located adjacent to at least one of the thermal image generators; and
making the carrier to receive a magnetic signal sent by the at least one magnetic signal generator, and charging the carrier according to the magnetic signal.

6. The thermal image positioning method as claimed in claim 5, wherein the magnetic signal is at least one of a magnetic resonance signal and a magnetic induction signal.

7. The thermal image positioning method as claimed in claim 1, wherein after the step of disposing the plurality of the thermal image generators in the space, the method further comprises:
obtaining position information of the thermal image generators in the space through a global positioning system; and
making the carrier to move to one of the thermal image generators according to the position information.

8. The thermal image positioning method as claimed in claim 7, wherein after the step of making the carrier to move to one of the thermal image generators according to the position information further comprises:
making the thermal image receiver to receive a selected thermal image generated by a selected thermal image generator, and moving the carrier to another one of the thermal image generators according to the selected thermal image.

9. The thermal image positioning method as claimed in claim 1, wherein the thermal image comprises at least one of a general image, a text and a code recording information.

10. A thermal image positioning system, comprising:
a plurality of thermal image generators, disposed in a space to respectively generate a plurality of thermal images;
a carrier, moving according to the thermal images;
a controller, disposed on the carrier; and
a thermal image receiver, disposed on the carrier and coupled to the controller, and receiving the thermal images,
wherein the controller respectively generates a plurality of distance information according to the thermal images, and generates coordinate information of the space according to the plurality of distance information.

11. The thermal image positioning system as claimed in claim 10, wherein the controller generates each distance information corresponding to each of the thermal image generators according to a color variation of each of the thermal images.

12. The thermal image positioning system as claimed in claim 10, wherein the controller recognizes a display pattern of each of the thermal images, such that the carrier executes an operation instruction according to the display pattern.

13. The thermal image positioning system as claimed in claim 10, further comprising:
at least one magnetic signal generator, located adjacent to at least one of the thermal image generators, and disposed to generate a magnetic signal.

14. The thermal image positioning system as claimed in claim 11, wherein the carrier further comprises:
a magnetic signal receiver, receiving the magnetic signal; and
a power management circuit, coupled to the magnetic signal receiver, converting the magnetic signal into a charging voltage, and charging an energy storage device on the carrier by using the charging voltage.

15. The thermal image positioning system as claimed in claim 12, wherein the magnetic signal is at least one of a magnetic resonance signal and a magnetic induction signal.

16. The thermal image positioning system as claimed in claim 10, wherein the controller receives position information of the thermal image generators in the space,
wherein the position information is obtained through a global positioning system.

17. The thermal image positioning system as claimed in claim 10, wherein the controller makes the carrier to move to one of the thermal image generators according to the position information.

18. The thermal image positioning system as claimed in claim 15, wherein the thermal image receiver receives a selected thermal image generated by the selected thermal image generator, and the controller makes the carrier to move to another one of the thermal image generators according to the selected thermal image.

19. The thermal image positioning system as claimed in claim 10, wherein the thermal image comprises at least one of a general image, a text and a code recording information.
